(19) United States
(12) Patent Application Publication
(10) Pub. No.: US 2024/0270571 A1
(43) Pub. Date: Aug. 15, 2024

(54) SYSTEMS AND METHODS FOR REDUCING WATER CONSUMPTION AND RECOVERING ACTIVATING METALS FROM ALUMINUM-WATER REACTIONS

(71) Applicant: Massachusetts Institute of Technology, Cambridge, MA (US)

(72) Inventors: Douglas P. Hart, Charlestown, MA (US); Peter Godart, Cambridge, MA (US)

(73) Assignee: Massachusetts Institute of Technology, Cambridge, MA (US)

(21) Appl. No.: 18/568,792

(22) PCT Filed: Jun. 7, 2022
(86) PCT No.: PCT/US2022/032487

§ 371 Date: Dec. 8, 2023

Related U.S. Application Data
(60) Provisional application No. 63/209,342, filed on Jun. 10, 2021.

(51) Int. Cl. C01B 3/08; B01J 19/24

(52) U.S. Cl. CPC C01B 3/08; B01J 19/24

(57) ABSTRACT

Systems and methods related to aluminum-water reactions, hydrogen gas production, and the recovery of activating metals are generally described.

### CROSS-REFERENCE TO RELATED APPLICATIONS

This application claims the benefit under 35 U.S.C. § 119(e) of U.S. provisional application Ser. No. 63/209,342 filed Jun. 10, 2021, the disclosure of which is incorporated by reference in its entirety.

### TECHNICAL FIELD

Systems and methods related to aluminum-water reactions, hydrogen gas production, and the recovery of activating metals are generally described.

### BACKGROUND

Hydrogen gas has been well recognized as an emission-free fuel holding promise for a more sustainable energy economy compared to fossil fuels. Oxidation-reduction reactions involving metals can produce hydrogen on-demand, eliminating the cost and safety concerns of storing hydrogen as a gas or liquid at high-pressure. Aluminum (Al), for example, has an energy density about two times greater than diesel fuel and forty times greater than lithium ion, and reacts with water to produce hydrogen at room temperature and atmospheric pressure. Using aluminum as a bulk fuel source, however, presents certain challenges associated with water consumption.

### SUMMARY

Systems and methods related to aluminum-water reactions, hydrogen gas production, and the recovery of activating metals are generally described. The subject matter of the present disclosure involves, in some cases, interrelated products, alternative solutions to a particular problem, and/or a plurality of different uses of one or more systems and/or articles.

According to some embodiments, a method of producing hydrogen gas is described, the method comprising: reacting an activated aluminum composition comprising aluminum and an activating composition with a solution comprising water and at least one selected from the group of an ionic salt, a hydroxide, and an acid in a reaction chamber to produce hydrogen gas and one or more reaction products; and forming a separate phase including the activating composition after reacting the activated aluminum with the water.

In certain embodiments, a system is described, the system comprising: a first reservoir configured to contain an activated aluminum composition comprising aluminum and an activating composition; a second reservoir configured to contain an ionic salt, a hydroxide, and/or an acid; and a reaction chamber in fluid communication with the first reservoir and the second reservoir, wherein the first reservoir is configured to dispense the activated aluminum into the reaction chamber, wherein the second reservoir is configured to dispense the ionic salt, the hydroxide, and/or the acid into the reaction chamber, and wherein the reaction chamber is configured such that the activated aluminum reacts with water in the reaction chamber in the presence of the ionic salt, the hydroxide, and/or the acid to produce hydrogen gas and one or more reaction products.

According to some embodiments, a system is described, the system comprising: a first reservoir configured to contain an activated aluminum composition comprising aluminum and an activating composition; a second reservoir configured to contain a solution comprising water and an ionic salt, a hydroxide, and/or an acid dissolved in the water; a reaction chamber in fluid communication with the first reservoir and the second reservoir, wherein the first reservoir is configured to dispense the activated aluminum into the reaction chamber, wherein the second reservoir is configured to dispense the solution into the reaction chamber, and wherein the reaction chamber is configured such that the activated aluminum reacts with the water in the presence of the ionic salt, the hydroxide, and/or the acid to produce hydrogen gas and one or more reaction products, wherein the amount of the ionic salt, the hydroxide, and/or the acid is sufficient to cause the activating composition to form a separate phase after the activated aluminum reacts with the water; a separation system configured to separate the activating composition from one or more reaction products; and a recovery chamber in fluid communication with the reaction chamber, wherein the recovery chamber is configured to receive the separate phase of the activating composition from the reaction chamber.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A shows, according to certain embodiments, a schematic top-view diagram of a system comprising a first reservoir, a second reservoir, and a reaction chamber;

FIG. 1B shows, according to certain embodiments, a schematic side-view diagram of the system in FIG. 1A;

FIG. 2A shows, according to certain embodiments, a schematic top-view diagram of a system comprising a first reservoir, a second reservoir, a third reservoir, and a reaction chamber;

FIG. 2B shows, according to certain embodiments, a schematic side-view diagram of the system in FIG. 2A;

FIG. 3A shows, according to certain embodiments, a schematic top-view diagram of a system comprising a first reservoir, a second reservoir, a reaction chamber, and a separation system;

FIG. 3B shows, according to certain embodiments, a schematic side-view diagram of the system in FIG. 3A;

FIG. 4A shows, according to certain embodiments, a schematic top-view diagram of a system comprising a first reservoir, a second reservoir, one or more processors, a reaction chamber, and a separation system;

FIG. 4B shows, according to certain embodiments, a schematic side-view diagram of the system in FIG. 4A;

FIG. 5A shows, according to certain embodiments, a schematic top-view diagram of a system comprising a first reservoir, a second reservoir, one or more processors, a reaction chamber, a separation system, and a recovery chamber;

FIG. 5B shows, according to certain embodiments, a schematic side-view diagram of the system in FIG. 5A;

FIG. 6 shows, according to certain embodiments, the hydrogen yield fraction of the reaction between activated aluminum and water in the presence of NaOH as a function of pH;

FIG. 7 shows, according to certain embodiments, the reaction product of the reaction between activated aluminum and water in the presence of NaOH;

FIG. 8 shows, according to certain embodiments, a schematic flow diagram of a system for reacting activated aluminum with water in the presence of NaOH;

FIG. 9A shows, according to certain embodiments, a scanning electron microscopy (SEM) image of an activating composition after an aluminum-water reaction;

FIG. 9B shows, according to certain embodiments, an Energy-Dispersive X-Ray Spectroscopy (EDS) atomic map of the activating composition shown in FIG. 9A;

FIG. 10A, according to certain embodiments, a SEM image of an agglomeration resulting from an aluminum-water reaction without an ionic salt, hydroxide, or an acid; and

FIG. 10B shows an EDS atomic map of the agglomeration shown in FIG. 10A.

### DETAILED DESCRIPTION

Aluminum metal and water react to produce hydrogen gas according to either of the following exothermic reactions shown in reaction (1) and (2):

$$2 A l + 4 {H}_{2} O \to 3 {H}_{2} + 2 A l O ( O H ) + Q 1 \qquad ( 1 )$$

$$2 A l + 6 {H}_{2} O \to 3 {H}_{2} + 2 A {l ( O H )}_{3} + Q 2 , \qquad ( 2 )$$

wherein Q1 and/or Q2 is between 840 kJ to 880 kJ of heat, depending on the extent of the reaction. Under ambient conditions, however, an oxide layer forms on the surface of aluminum as it is exposed to atmospheric oxygen, therefore preventing the ability of the underlying pure aluminum metal from substantially reacting with water. An activating composition may be used to permeate into the grain boundaries and/or subgrain boundaries of the aluminum, therefore disrupting the oxide layer and facilitating the reaction between aluminum and water.

The Inventors have realized that an obstacle to achieving the full potential of aluminum as a fuel source is the inability to easily recover the activating composition after the reaction between aluminum and water is complete. The components of the activating composition (e.g., gallium and/or indium) may separate from one another during the course of the reaction, therefore increasing their respective melting points; allowing one or more of the components of the activating composition (e.g., gallium) to oxidize; and/or dispersing one or more components of the activating composition into microdroplets dispersed in the reaction products, all of which may complicate separation of the activating composition from the mixture of reaction products. Conventional methods of recovering the activating composition use complex and inefficient chemical processes, resulting in low recovery yields. This is in contrast to the mechanical separation based processes disclosed herein.

Another obstacle associated with realizing the potential of aluminum as a fuel source is that the reaction between aluminum and water necessitates a significant amount of excess water to reach the maximum yield of hydrogen than is suggested by the stoichiometry in either reaction (1) or (2). In some conventional cases, for example, maximum hydrogen yields are not achieved until nearly ten times stoichiometric water ratios are employed. Requiring a large excess of water is impractical for closed system power applications that store both the aluminum and the water. Furthermore, the energy density and specific energy of such systems significantly decreases, which results in aluminum being a less viable fuel option.

The Inventors have realized and appreciated that reacting an activated aluminum composition with water in the presence of an ionic salt (e.g., NaCl), a hydroxide (e.g., NaOH), and/or an acid (e.g., HCl) provides a tandem effect of allowing for recovery of the activating composition used to activate the aluminum while also decreasing water consumption. Without wishing to be bound by theory, reacting the activated aluminum with water in the presence of the ionic salt, the hydroxide, and/or the acid prevents the components of the activating composition from separating from one another and allows the activating composition to be separated from excess reactants and/or other reaction products via a number of density-driven mechanical processes. Recovering the activating composition is advantageous, as the activating composition is expensive and can be harmful to the environment in large quantities. In addition, including an ionic salt, a hydroxide, and/or an acid during the reaction of the activated aluminum with water may increase the hydrogen yield. As explained in further detail herein, for example, the ionic cations and/or ionic anions of the ionic salt, the hydroxide, and/or the acid (e.g., Na⁺, Cl⁻) may adhere to the surface of the activating composition. Without wishing to be bound by theory, the ionic cations and/or anions may advantageously affect the zeta potential and/or the surface tension of the activating composition such that the activating composition remains a colloidal composition after the reaction between the activated aluminum and water.

As used herein, the term “ionic salt” is given its ordinary meaning in the art and generally refers to a chemical compound consisting of an ionic assembly of cations and anions. The term “hydroxide” is also given its ordinary meaning in the art and generally refers to a chemical compound comprising a diatomic anion with the formula OH. In some embodiments, the hydroxide may be a base (e.g., a chemical compound capable of either accepting a proton, such as a Bronstead-Lowry base, or donating an electron pair, such as a Lewis base). In certain embodiments, the hydroxide may be an ionic salt. The term “acid” is also given its ordinary meaning in the art and generally refers to a chemical compound capable of either donating a proton (i.e., a Bronsted-Lowry acid), or accepting an electron pair (i.e., a Lewis acid). According to some embodiments, the acid may be an ionic salt.

It may be desirable to separate and/or recover the activating composition after the reaction between the activated aluminum composition and water. According to certain embodiments, the use of an ionic salt, a hydroxide, and/or an acid advantageously permits the activating composition to be phase segregated, therefore enabling separation and recovery of the activating composition via simple mechanical separations due to the activating composition being denser than the reactants and reaction products, as explained in further detail below. Without wishing to be bound by theory, one or more components of the ionic salt, the hydroxide, and/or the acid, such as the ionic cation (e.g., Na⁺) and/or the ionic anion (e.g., Cl⁻), may adhere and/or otherwise aggregate on the surface of the activating composition as the activating composition activates the aluminum. The adherence of the ionic cation to the surface of the activating composition prevents separation and/or oxidation of the components of the activating composition, therefore enabling simple mechanical separation of the activating composition.

The use of the ionic salt, the hydroxide, and/or the acid may also decrease the amount of water consumption necessary to reach the maximum yield of hydrogen, or conversely increase the hydrogen yield for a given amount of water. Without wishing to be bound by theory, for example, a hydroxide (e.g., NaOH) may be employed, in certain non-limiting embodiments, to increase the alkalinity of the water reactant, therefore favoring formation of Al(OH)₃, as shown in reaction (2), and driving the reaction to completion. In certain embodiments wherein AlOOH is formed, as shown in reaction (1), water may intercalate between layers of the reaction product, therefore preventing water from reaching the aluminum fuel.

The separate phase of the activating composition may, in some embodiments, comprise a colloidal aggregation of the activating composition dispersed in an additional phase. The additional phase may, in some embodiments, comprise one or more reaction products (e.g., AlO(OH), Al(OH)₃, as shown in reactions (1) and (2)), unreacted water, and/or excess and/or leftover ionic salt, hydroxide, and/or acid (e.g., dissolved and/or suspended in the water).

In some embodiments, it may be desirable to maintain the mixture of the activating composition and the one or more reaction products in a gel state to facilitate separation of the activating composition from the one or more reaction products while avoiding crystallization of the one or more reaction products. In such an embodiment, the mixture including the activating composition and the one or more reaction products may comprise any of a variety of suitable amounts of water to maintain a gel state. In some embodiments, for example, the mixture comprises water in an amount greater than or equal to 1 wt. %, greater than or equal to 5 wt. %, greater than or equal to 10 wt. %, greater than or equal to 15 wt. %, or greater than or equal to 20 wt. % versus the total weight of the mixture. In certain embodiments, the mixture comprises water in an amount less than or equal to 25 wt. %, less than or equal to 20 wt. %, less than or equal to 15 wt. %, less than or equal to 10 wt. %, or less than or equal to 5 wt. % versus the total weight of the mixture. Combinations of the above recited ranges are also possible (e.g., the mixture comprises water in an amount between greater than or equal to 1 wt. % and less than or equal to 25 wt. % versus the total weight of the mixture, the mixture comprises water in an amount between greater than or equal to 10 wt. % and less than or equal to 15 wt. % versus the total weight of the wetted activating composition). Other ranges are also possible.

The systems described herein may comprise a separation mechanism (e.g., a separation system), in some embodiments, that is configured to separate the activating composition from one or more reaction products. Any of a variety of suitable separation systems may be employed. In some embodiments, for example, the separation system is a gravity-based system and/or a separating funnel-based system. The gravity-based system may include, for example, a step-wise fluidic connection between the reaction chamber and the separation system, wherein at least a portion of the reaction chamber is positioned at a greater height than the separation system relative to a direction of gravity, such that the separate phase of the activating composition flows vertically downward to the separation system under the force of gravity. A separation funnel may be used, in some embodiments, wherein the separation funnel is configured to perform extractions to separate the separate phase of the activating composition from the additional phase. According to some embodiments, an electric field may be applied to separate the activating composition. For example, in certain embodiments, the activating composition and the one or more reaction products may be subjected to electrowetting. Without wishing to be bound by theory, the activating composition may form an electronic double layer in the presence of an ionic solution. For example, in some embodiments, the activating composition may be at least partially positively charged in an alkaline solution or at least partially negatively charged in an acidic solution. In some such embodiments, an external electric field (e.g., electrowetting) may be applied to separate the activating composition.

After separating the activating composition from the additional phase, the activating composition may be flowed to a recovery chamber in fluid communication with the reaction chamber and the separation system. In some embodiments, the recovery chamber is configured to receive the separate phase of the activating composition and maintain a wetted activated composition. According to some embodiments, it may be advantageous to avoid substantially drying the activated composition after separation in order to avoid oxidation and/or separation of one or more components of the activating composition.

In certain embodiments, a recovery chamber of a system may also be configured to recycle the activating composition for use in the subsequent activation of additional aluminum for aluminum-water reactions.

According to some embodiments, an advantageously high amount of the activating composition may be recovered after the reaction between the activated aluminum and water. In some embodiments, for example, greater than or equal to 95%, greater than or equal to 96%, greater than or equal to 97%, greater than or equal to 98%, greater than or equal to 99%, or greater than or equal to 99.9% of the activating composition is recovered after the reaction between the activated aluminum and water. In some embodiments, less than or equal to 100%, less than or equal to 99.9%, less than or equal to 99%, less than or equal to 98%, less than or equal to 97%, or less than or equal to 96% of the activating composition is recovered after the reaction between the activated aluminum and water. Combinations of the above recited ranges are also possible (e.g., between greater than or equal to 96% and less than or equal to 100% of the activating composition is recovered after the reaction between the activated aluminum and water, between greater than or equal to 98% and less than or equal to 99.9% of the activating composition is recovered after the reaction between the activated aluminum and water).

According to certain embodiments, a method of producing hydrogen gas by reacting an activated aluminum composition with water in the presence of an ionic salt, a hydroxide, and/or an acid is described herein. In some embodiments, for example, the method comprises dispensing the activated aluminum composition (e.g., aluminum activated by the activating composition) and the ionic salt, the hydroxide, and/or the acid into a reaction chamber. As explained in further detail below, the activated aluminum composition may be dispensed from a first reservoir into the reaction chamber, and the ionic salt, the hydroxide, and/or the acid may be dispensed from a second reservoir into the reaction chamber.

In some embodiments, the method comprises reacting the activated aluminum composition comprising aluminum and an activating composition with a solution comprising water and at least one selected from the group of an ionic salt, a hydroxide, and an acid in the reaction chamber. Hydrogen gas and one or more reaction products (e.g., AlO(OH), Al(OH)₃, as shown in reactions (1) and (2)) may be produced as a result of reacting the activated aluminum composition with the solution comprising water and an ionic salt, a hydroxide, and/or an acid. The hydrogen gas may be removed from the reaction chamber via any of a variety of suitable means, including, for example, through one or more gas outlets in fluid communication with the reaction chamber. In certain embodiments, the exothermic heat from the reaction (e.g., Q1, Q2, as shown in reactions (1) and (2)), may be recovered and used for one or more applications, such as, for example, a heat pump and/or direct heating applications.

According to some embodiments, the method comprises forming a separate phase including the activating composition after reacting the activated aluminum composition with the water. Without wishing to be bound by theory and as explained herein, the separate phase including the activating composition is formed due to the adherence of ionic cations (e.g., Na⁺) and/or ionic anions (e.g., Cl⁻) to the surface of the activating composition. In some embodiments, the separate phase of the activating composition may then be separated from the one or more reaction products via a mechanical separation, as described herein. The separate phase of the activating composition is then flowed to a recovery chamber, in certain embodiments, wherein the activating composition may be subsequently recovered and/or recycled for use in another aluminum-water reaction.

The ionic salt, the hydroxide, and/or the acid may be provided in any desirable form. In some embodiments, for example, the ionic salt, the hydroxide, and/or the acid is dissolved and/or suspended in solution (e.g., water or an aqueous solution). In other embodiments, the ionic salt, the hydroxide, and/or the acid is provided as a solid material. For example, in some embodiments, the ionic salt, the hydroxide, and/or the acid may be provided as a powder that may be added to an appropriate reaction chamber in which water and activated aluminum are to be reacted.

According to certain embodiments, the ionic salt comprises NaCl, KCl, NaHCO₃, MgCl₂, CaCl₂), and/or Al₂(SO₄)₃. Other ionic salts are also possible.

In some embodiments, the hydroxide comprises NaOH, KOH, Ca(OH)₂, and/or Mg(OH)₂. Other hydroxides are also possible.

In certain embodiments, the acid comprises HCl, H₂SO₄, and/or CH₃COOH. Other acids are also possible.

As explained above, the ionic salt, the hydroxide, and/or the acid may be dissolved in solution (e.g., water or an aqueous solution). The ionic salt, the hydroxide, and/or the acid may have any of a variety of suitable concentrations. In some embodiments, for example, the concentration of the ionic salt, the hydroxide, and/or the acid dissolved in solution (e.g., water or an aqueous solution) is greater than or equal to 0.1 M, greater than or equal to 0.5 M, greater than or equal to 1 M, greater than or equal to 1.5 M, greater than or equal to 2 M, greater than or equal to 2.5 M, greater than or equal 3 M, greater than or equal to 3.5 M, greater than or equal to 4 M, greater than or equal to 4.5 M, greater than or equal to 5 M, greater than or equal to 6 M, greater than or equal to 7 M, greater than or equal to 8 M, greater than or equal to 9 M, or more. In certain embodiments, the concentration of the ionic salt, the hydroxide, and/or the acid dissolved in solution is less than or equal to a solubility limit of the ionic salt, the hydroxide, and/or the acid in the solution. For example, in some embodiments, the concentration of the ionic salt, the hydroxide, and/or the acid dissolved in solution (e.g., water or an aqueous solution) is less than or equal to 10 M, less than or equal to 9 M, less than or equal to 8 M, less than or equal to 7 M, less than or equal to 6 M, less than or equal to 5 M, less than or equal to 4.5 M, less than or equal to 4 M, less than or equal to 3.5 M, less than or equal to 3 M, less than or equal to 2.5 M, less than or equal to 2 M, less than or equal to 1.5 M, less than or equal to 1 M, less than or equal to 0.5 M, or less. Combinations of the above recited ranges are also possible (e.g., the concentration of the ionic salt, the hydroxide, and/or the acid in solution is greater than or equal to 0.1 M and less than or equal to the solubility limit of the ionic salt, the hydroxide, and/or the acid in the solution, the concentration of the ionic salt, the hydroxide, and/or the acid in solution is greater than or equal to 4 M and less than or equal to 6 M). Other ranges are also possible.

As described herein, the aluminum may be activated with an activating composition. The activating composition may, in certain embodiments, permeate into the grain boundaries and/or subgrain boundaries of the aluminum to disrupt the oxide layer formed on the aluminum, thereby facilitating the reaction between aluminum and water.

The activating composition may comprise any of a variety of suitable materials. In some embodiments, for example, the activating composition comprises gallium and/or indium. Without wishing to be bound by theory, the gallium and/or indium may permeate through one or more grain boundaries and/or subgrain boundaries of the aluminum. The activating composition may be an eutectic composition, or close to an eutectic composition, including, for example, an eutectic composition of gallium and indium. In one such embodiment, the activating composition may comprise gallium and indium where the portion of the activating composition may have a composition of about 70 wt. % to 80 wt. % gallium and 20 wt. % to 30 wt. % indium, though other weight percentages are also possible.

In certain embodiments, the activating composition may be incorporated into an alloy with the aluminum. The metal alloy may comprise any activating composition in any of a variety of suitable amounts. In some embodiments, for example, the metal alloy comprises greater than or equal to 0.1 wt. % of the activating composition, greater than or equal to 1 wt. %, greater than or equal to 5 wt. %, greater than or equal to 15 wt. %, greater than or equal to 30 wt. %, or greater than or equal to 45 wt. % of the activating composition based on the total weight of the metal alloy. In certain embodiments, the metal alloy comprises less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % of the activating composition based on the total weight of the metal alloy. Combinations of the above recited ranges are also possible (e.g., the metal alloy comprises greater than or equal to 0.1 wt. % and less than or equal to 50 wt. % of the activating composition based on the total weight of the metal alloy, the metal alloy comprises greater than or equal to 1 wt. % and less than or equal to 10 wt. % of the activating composition based on the total weight of metal alloy). Other ranges are also possible.

The activated aluminum may be provided in any desirable form. In certain embodiments, for example, the activated aluminum is provided as a slurry that includes a plurality of activated aluminum particles dispersed within the slurry. In other embodiments, the activated aluminum is provided as a plurality of activated aluminum particles in solid form (e.g., as a powder). The activated aluminum particles may be regularly shaped, such as spherical, or may be irregularly shaped chunks. The size of the activated aluminum particles may be uniform or varied. Alternatively, the activated aluminum particles may be provided in a more continuous form, such as a powder with any appropriate size distribution for a desired application.

The activated aluminum particles may have any of a variety of suitable maximum characteristic dimensions (e.g., diameter, length, height, width). In some embodiments, for example, the activated aluminum particles have an average maximum characteristic dimension less than or equal to 100 micrometers, less than or equal to 90 micrometers, less than or equal to 80 micrometers, less than or equal to 70 micrometers, less than or equal to 60 micrometers, less than or equal to 50 micrometers, less than or equal to 40 micrometers, less than or equal to 30 micrometers, less than or equal to 20 micrometers, or less. In certain embodiments, the activated aluminum particles have an average maximum characteristic dimension greater than or equal to 10 micrometers, greater than or equal to 20 micrometers, greater than or equal to 30 micrometers, greater than or equal to 40 micrometers, greater than or equal to 50 micrometers, greater than or equal to 60 micrometers, greater than or equal to 70 micrometers, greater than or equal to 80 micrometers, greater than or equal to 90 micrometers, or greater. Combinations of the above recited ranges are also possible (e.g., the activated aluminum particles have an average maximum characteristic dimension between less than or equal to 100 micrometers and greater than or equal to 10 micrometers, the activated aluminum particles have an average maximum characteristic dimension between less than or equal to 60 micrometers and greater than or equal to 40 micrometers). Other ranges are also possible.

In certain embodiments wherein the activated aluminum is provided as a slurry, the plurality of activated aluminum particles may be suspended in any appropriate carrier fluid. In some instances, for example, the carrier fluid may be a shear thinning fluid, though the disclosure is not limited to only using shear thinning fluids. As used herein, the phrase “shear thinning fluid” is given its ordinary meaning in the art and generally refers to a fluid whose viscosity decreases under shear strain. Any of a variety of suitable shear thinning fluids may be utilized. In some embodiments, for example, the carrier fluid may comprise oil, such as mineral oil, canola oil, and/or olive oil. In certain embodiments, the carrier fluid may comprise a grease, alcohol, or other appropriate material capable of suspending the water reactive particles in the carrier fluid. In certain embodiments, the carrier fluid comprises fumed silica thickening agents, or other appropriate thickening agents.

It should be understood that a slurry may have any appropriate ratio of activated aluminum particles to carrier fluid by weight. Further, without wishing to be bound by theory, the ratio of activated aluminum particles to carrier fluid in the slurry may affect the physical properties of the slurry. For example, a slurry that has a ratio of activated aluminum particles to fluid carrier of 90:10 by weight may be characterized as a paste, whereas a slurry with a ratio of 50:50 may flow more easily. In some applications, a ratio of activated aluminum particles to fluid carrier as low as 10:90 may be desirable. Accordingly, a ratio of activated aluminum particles to fluid carrier by weight may be between or equal to about 10:90 and 90:10, though other appropriate ranges both greater and less than those noted above are also contemplated. In some embodiments, the slurry may be produced in a colloid mill, although other methods of producing a slurry using any appropriate milling and/or mixing process are also contemplated as the disclosure is not limited in this regard.

In some embodiments, the use of a slurry as a liquid fuel source provides significant advantages, as compared to solid fuel sources (e.g., bulk aluminum metal), including higher packing fraction, case of storage (e.g., in articles and/or vessels with complex geometries), the ability to pump the liquid fuel source with low losses, and/or higher shelf stability. In certain embodiments, the slurry may be reacted with water nearly instantaneously due to a higher surface area contact between the water and the water reactive particles dispersed with the carrier fluid, therefore providing higher reaction rates (as compared to the use of solid fuel sources) and controlled hydrogen flow rates. Reactions between the liquid fuel source and water may also be quickly stopped by simply preventing two reactant streams from mixing with one another.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

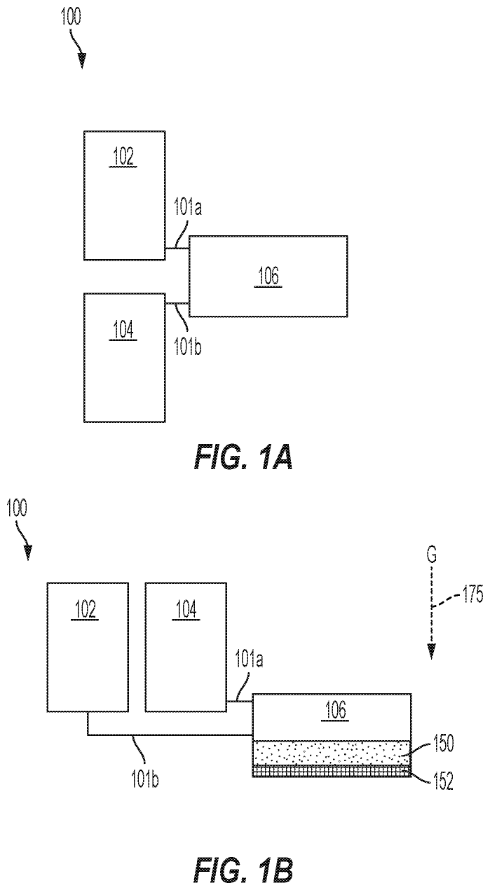

FIG. 1A shows, according to certain embodiments, a schematic top-view diagram of system 100 comprising first reservoir 102, second reservoir 104, and reaction chamber 106. FIG. 1B shows a schematic side-view diagram of the system in FIG. 1A. As shown in FIGS. 1A-1B, system 100 may comprise connections 101 (e.g., connection 101a connecting first reservoir 102 and reaction chamber 106 and connection 101b connecting second reservoir 104 and reaction chamber 106).

According to some embodiments, first reservoir 102 is configured to contain the activated aluminum composition. In certain embodiments, the activated aluminum composition comprises aluminum and an activating composition, as described herein. The activated aluminum composition may, in some embodiments, comprises a slurry that includes a plurality of activated aluminum particles dispersed within the slurry.

In some embodiments, first reservoir 102 is configured to dispense the activated aluminum composition into reaction chamber 106. In certain embodiments, for example, the activated aluminum composition may flow from first reservoir 102 into reaction chamber 106 via connection 101a. Depending on what form the activated aluminum is provided in, connection 101a, and/or any of the other connections described herein, may comprise one or more valves, dampers, pumps, other actuated hydraulic devices, conveyors, scoop-based dispensing systems, and/or any other appropriate type of construction capable of dispensing a desired amount of a material contained within a first reservoir or chamber to another reservoir or chamber of the system.

In certain embodiments, second reservoir 104 is configured to contain the ionic salt, the hydroxide, and/or the acid. Second reservoir 104 may be configured, in some embodiments, to contain a solution comprising water and the ionic salt, the hydroxide, and/or the acid dissolved and/or suspended in the water. In some embodiments, for example, the solution comprising water and an ionic salt may be concentrated seawater. As will be explained in greater detail below, second reservoir 104 may be configured to contain the ionic salt, the hydroxide, and/or the acid in solid form (e.g., as a powder), and the solid material may be hydrated in second reservoir 104 and/or in reaction chamber 106.

Second reservoir 104 may be configured, in some embodiments, to dispense the ionic salt, the hydroxide, and/or the acid into reaction chamber 106. In certain embodiments, for example, the ionic salt, the hydroxide, and/or the acid (e.g., a solution comprising water and the ionic salt, the hydroxide, and/or the acid dissolved and/or suspended in the water) may flow from second reservoir 104 into reaction chamber 106 via connection 101b. In other embodiments, the ionic salt, the hydroxide, and/or the acid may be dispensed from second reservoir 104 into reaction chamber 106 in solid form (e.g., as a powder). According to certain embodiments, the water to be used to react with the activated aluminum may be present in the reaction chamber and/or dispensed from second reservoir 104 as a solution containing the ionic salt, the hydroxide, and/or the acid in any desired concentration.

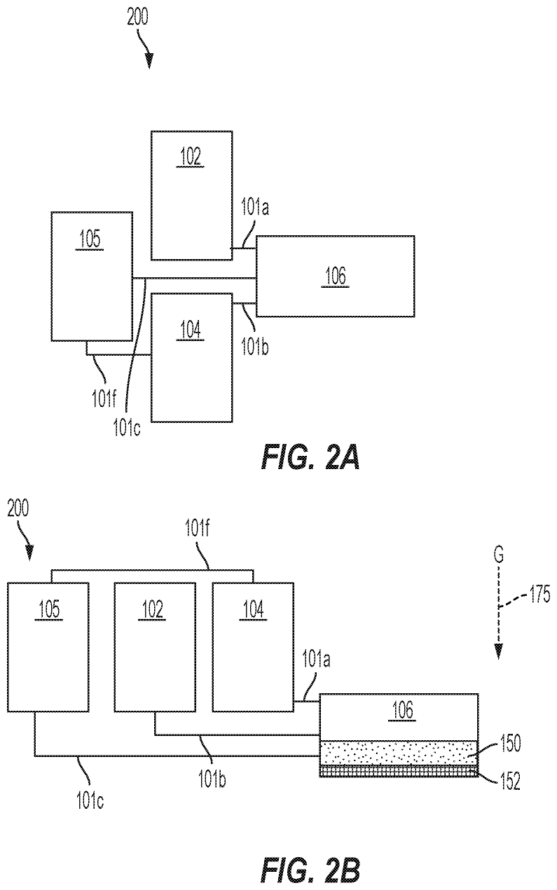

FIG. 2A shows, according to certain embodiments, a schematic top-view diagram of system 200 comprising first reservoir 102, second reservoir 104, third reservoir 105, and reaction chamber 106. FIG. 2B shows, a schematic side-view diagram of the system in FIG. 2A. First reservoir 102, second reservoir 104, and reaction chamber 106 may be configured as explained above with respect to FIGS. 1A-1B. Connections 101 (e.g., connection 101a connecting first reservoir 102 and reaction chamber 106, connection 101b connecting second reservoir 104 and reaction chamber 106, connection 101c connecting third reservoir 105 and reaction chamber 106, and connection 101f connecting third reservoir 105 and second reservoir 104) as shown in FIGS. 2A-2B may be any of the connections described above.

In certain embodiments, the system includes third reservoir 105, which may be configured to contain a separate volume of water to be used to react with the activated aluminum.

Third reservoir 105 may be configured, in some embodiments, to dispense the water into reaction chamber 106. For example, in certain embodiments, the water may flow from third reservoir 105 into reaction chamber 106 via connection 101c. In some embodiments, the water dispensed from third reservoir 105 into reaction chamber 106 may be in addition to the water from the solution comprising water and the ionic salt, the hydroxide, and/or the acid dissolved and/or suspended in the water dispensed from second reservoir 104 into reaction chamber 106.

According to some embodiments, third reservoir 105 may also be configured to dispense water into second reservoir 104. In certain embodiments, for example, the water may flow from third reservoir 105 into second reservoir 104 via connection 101f. In some such embodiments, the water may dissolve the ionic salt, the hydroxide, and/or the acid in solid form contained in second reservoir 104. However, embodiments in which a separate source of water is used for providing water to the second reservoir are also contemplated.

It should be understood that in the various embodiments described herein, first reservoir 102, second reservoir 104, and/or third reservoir 105 may have any of a variety of suitable shapes, sizes, and/or volumes depending on the desired application.

As shown in FIGS. 1A-1B, system 100 comprises reaction chamber 106. As explained above, reaction chamber 106 is in fluid communication with first reservoir 102 (e.g., via connection 101a) and second reservoir 104 (e.g., via connection 101b). As shown in FIGS. 2A-2B, reaction chamber 106 is in fluid communication with third reservoir 105 (e.g., via connection 101c).

Regardless of the specific construction for providing the materials to reaction chamber 106, reaction chamber 106 may be configured such that the activated aluminum composition (e.g., dispensed from first reservoir 102) reacts with water in reaction chamber 106 in the presence of the ionic salt, the hydroxide, and/or the acid (e.g., dispensed from second reservoir 104) to produce hydrogen gas and one or more reaction products.

According to some embodiments, the amount of the ionic salt, the hydroxide, and/or the acid dispensed from second reservoir 104 into reaction chamber 106 is at least an amount sufficient to cause the activating composition to form a separate phase after the activated aluminum composition reacts with the water in reaction chamber 106. Without wishing to be bound by theory and as explained herein, the ionic cation (e.g., Na⁺) and/or the ionic anion (e.g., Cl⁻) of the ionic salt, the hydroxide, and/or the acid may adhere and/or otherwise aggregate on the surface of the activating composition as the activating composition activates the aluminum. In some embodiments, the adherence and/or aggregation of the ionic cation and/or the ionic anion prevents components of the activating composition from separating or oxidizing, resulting in the activating composition forming one or more separate phases after the aluminum is consumed by the reaction with water. According to some embodiments, the activating composition may form one or more macrosized beads of material that may be subjected to further separation from one or more additional materials. Referring, for example, to FIG. 1B, after the activated aluminum composition reacts with the water, reaction chamber 106 may comprise separate phase of the activating composition 152 and additional phase 150. Additional phase 150 may, in some embodiments, comprise one or more of the following components: one or more reaction products (e.g., AlO(OH), Al(OH)₃, as shown in reactions (1) and (2)), unreacted water, and/or excess and/or leftover ionic salt, hydroxide, and/or acid (e.g., dissolved and/or suspended in the water).

In certain embodiments, separate phase of the activating composition 152 may advantageously flow downwards to the bottom of reaction chamber 106 relative to direction of gravity 175. Without wishing to be bound by theory, the molecular weight of the one or more components of separate phase of the activating composition 152 (e.g., gallium and/or indium) is greater than the molecular weight of each of the components of additional phase 150. Therefore, separate phase of the activating composition 152, being heavier than additional phase 150, is advantageously easily separable from additional phase 150.

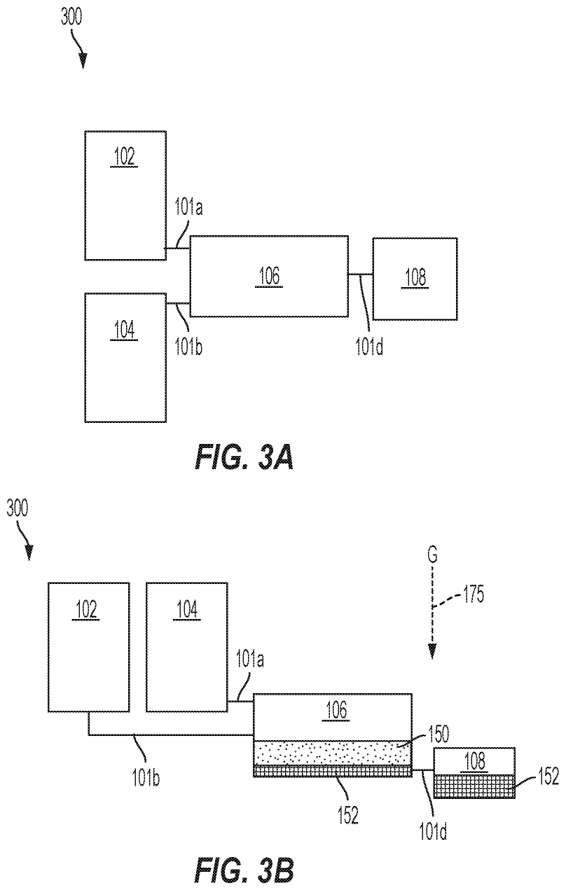

FIG. 3A shows, according to certain embodiments, a schematic top-view diagram of system 300 comprising first reservoir 102, second reservoir 104, reaction chamber 106, and separation system 108. FIG. 3B shows a schematic side-view diagram of the system in FIG. 3A. First reservoir 102, second reservoir 104, and reaction chamber 106 may be configured as explained above with respect to FIGS. 1A-1B. Connections 101 (e.g., connection 101a connecting first reservoir 102 and reaction chamber 106, connection 101b connecting second reservoir 104 and reaction chamber 106, and connection 101d connecting reaction chamber 106 and separation system 108) as shown in FIGS. 3A-3B may be any of the connections described above.

As explained herein, separation system 108 may comprise any of a variety of suitable separation mechanisms. In some embodiments, for example, and as shown in FIG. 3B, separation system 108 comprises a gravity-based separation system. Referring, for example, to FIG. 3B, separate phase of the activating composition 152 may separate from additional phase 150 by flowing in a downward direction relative to gravity 175 into separation system 108 via connection 101d. In certain embodiments, the outlet port of reaction chamber 106 leading to connection 101d may be located on a portion of reaction chamber 106 below a height at which the reactants and/or reaction products are expected to be located after and/or during the reaction. In some embodiments, the inlet port of separation system 108 leading from connection 101d may correspondingly be located at a similar height at or below a threshold height for separation of separate phase of the activating composition 152. According to certain embodiments, separation system 108 may be located below reaction chamber 106 in a downward direction relative to gravity 175. As explained herein, other separation systems, such as a separating funnel-based system or application of an external electric field, may also be employed, as the disclosure is not meant to be limiting in this regard.

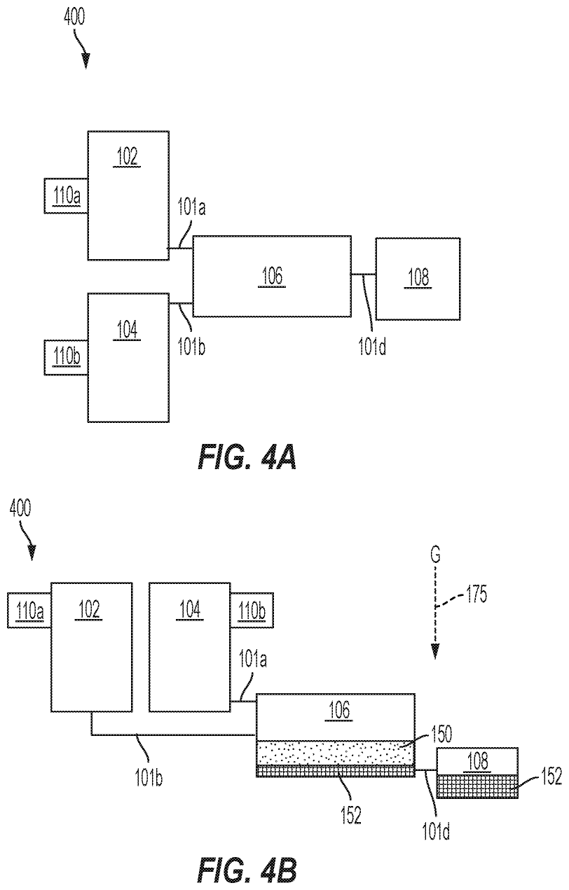

FIG. 4A shows, according to certain embodiments, a schematic top-view diagram of a system comprising first reservoir 102, second reservoir 104, one or more processors 110, reaction chamber 106, and separation system 108. FIG. 4B shows a schematic side-view diagram of the system in FIG. 4A. First reservoir 102, second reservoir 104, and reaction chamber 106 may be configured as explained above with respect to FIGS. 1A-1B. Separation system 108 may be configured as explained above with respect to FIGS. 3A-3B. Connections 101 (e.g., connection 101a connecting first reservoir 102 and reaction chamber 106, connection 101b connecting second reservoir 104 and reaction chamber 106, and connection 101d connecting reaction chamber 106 and separation system 108) as shown in FIGS. 4A-4B may be any of the connections described above. In some embodiments, the one or more processors (e.g., processor 110a and processor 110b) are associated with corresponding memory including processor executable instructions that when executed are configured to control the amount of the activated aluminum composition from first reservoir 102 and/or the amount of the ionic salt, the hydroxide, and/or the acid (e.g., the solution comprising water and the ionic salt, the hydroxide, and/or the acid dissolved and/or suspended in the water) from second reservoir 104 entering reaction chamber 106 as well as any other appropriate material from any other reservoir of the system. In certain embodiments, the one or more processors may control the flow rate of the material in addition to the amount of material entering the reaction chamber from their respective reservoirs.

Depending on the embodiment, the one or more processors may be configured to control any appropriate dispensing system for dispensing material from a corresponding reservoir to the reaction chamber including, for example, one or more pumps (e.g., vacuum pumps), valves, conveyor systems, and/or any other appropriate dispensing system as previously described.

As shown in FIGS. 4A and 4B, processor 110a may be associated with first reservoir 102 (e.g., to control the amount and/or flow rate of the activated aluminum composition entering reaction chamber 106) and processor 110b may be associated with second reservoir 104 (e.g., to control the amount and/or flow rate of the ionic salt, the hydroxide, and/or the acid entering reacting chamber 106). Although not shown in the figures, a processor may be also associated with third reservoir 105 to, for example, control the amount and/or flow rate of water entering reaction chamber 106 from third reservoir 105.

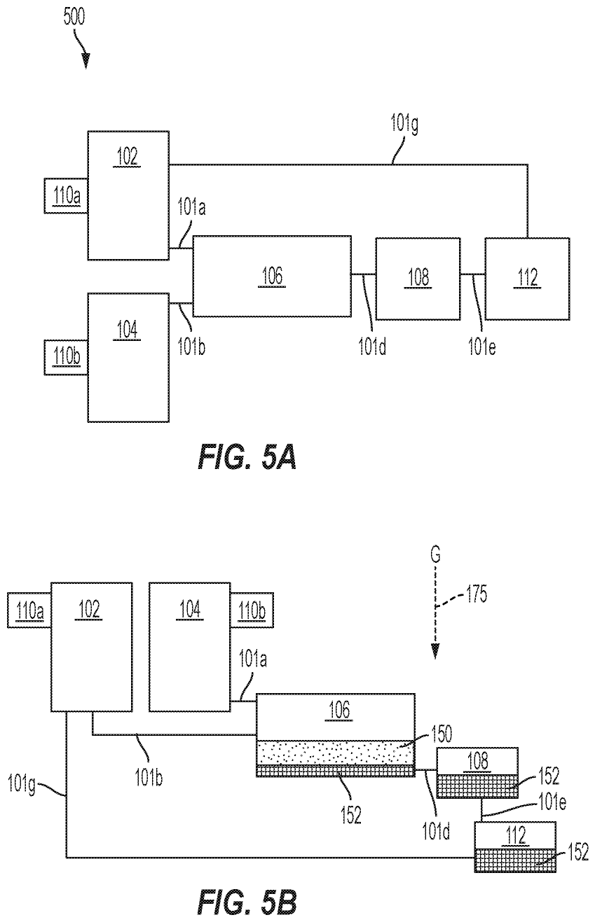

FIG. 5A shows, according to certain embodiments, a schematic top-view diagram of a system comprising first reservoir 102, second reservoir 104, one or more processors 110, reaction chamber 106, separation system 108, and recovery chamber 112. FIG. 5B shows a schematic side-view diagram of the system in FIG. 5A. First reservoir 102, second reservoir 104, and reaction chamber 106 may be configured as explained above with respect to FIGS. 1A-1B. Separation system 108 may be configured as explained above with respect to FIGS. 3A-3B. One or more processors 110 may be configured as explained above with respect to FIGS. 4A-4B. Connections 101 (e.g., connection 101a connecting first reservoir 102 and reaction chamber 106, connection 101b connecting second reservoir 104 and reaction chamber 106, connection 101d connecting reaction chamber 106 and separation system 108, connection 101e connecting separation system 108 and recovery chamber 112, and connection 101g connecting recovery chamber 112 and first reservoir 102) as shown in FIGS. 5A-5B may be any of the connections described above.

In some embodiments, recovery chamber 112 is configured to receive separate phase of the activating composition 152 from reaction chamber 106. In certain embodiments, separate phase of the activating composition 152, which, as shown in FIG. 5B, has been separated from other phase 150 via separation system 108, may flow from separation system 108 into recovery chamber 112 via connection 101e. After recovering separate phase of the activating composition 152, the activating composition may be recycled to first reservoir 102 via connection 101g, in some embodiments, to be used to activate more aluminum for a subsequent reaction between activated aluminum and water.

Recovery chamber 112 may also be configured, in some embodiments, to receive one or more components of additional phase 150 (e.g., one or more reaction products, the ionic salt, the hydroxide, and/or the acid). Although not shown in the figures, a system may include a plurality of recovery chambers each configured to receive a separate material, for example, a first recovery chamber configured to receiver separate phase of the activating composition 152, a second recovery chamber configured to receive one or more reaction products (e.g., AlO(OH), Al(OH)₃, as shown in reactions (1) and (2)), and a third recovery chamber configured to receive excess and/or leftover ionic salt, hydroxide, and/or acid (e.g., dissolved and/or suspended in the water).

The following examples are intended to illustrate certain embodiments of the present disclosure, but do not exemplify the full scope of the disclosure.

### Example 1

The following example describes the efficacy of adding various ionic salts, hydroxides, and/or acids to an aluminum-water reaction environment to enable mechanical recovery of the activating gallium-indium alloy as a liquid metal alloy. Various ionic aqueous solutions were prepared by dissolving salts, including NaCl, KCl, CaCl₂), MgCl₂, and NaHCO₃, into previously deionized water at molar concentrations ranging from 0.1 M to 5 M in increments of 0.2 M. Each solution was prepared to contain a single salt species. For each combination of ionic salt and concentration, 0.3 g of gallium-indium-activated aluminum were reacted in 10 mL of solution within a 100 mL Erlenmeyer flask. The top opening of the flask was covered except for a small opening, 3 mm in diameter, to allow for hydrogen to escape, while also slowing the rate of evaporation of the water within the flask. All reactions were carried out at an initial temperature and pressure of 20° C. and 1 atm, respectively. At all combinations of salts and concentrations listed above, liquid gallium-indium was observed to emerge from solution at the bottom of each flask. In each case, the liquid metal alloy was collected after the completion of the aluminum-water reaction, submerged in deionized water for a minimum of 48 hours, dried, and weighed. For each trial, the amount of eutectic collected was compared against the initial mass of the treated aluminum, whose aluminum content was known, allowing for the computation of the gallium-indium recovery fraction. In all cases, the computed recovery fractions were within error bars (±0.05) of 1 (i.e., complete recovery of the activating compounds).

In one trial, 3 g of activated aluminum was reacted in 20 mL of 3.9 M NaCl solution under otherwise similar conditions as the previously enumerated experiments. After 48 hours, the liquid metal was physically separated from the bulk solution using a syringe and submerged in deionized water for an additional 48 hours. The liquid metal was dried and weighed, and the final reported mass was 0.247 g of an expected 0.248 g, resulting in a recovery fraction of 0.996±0.008.

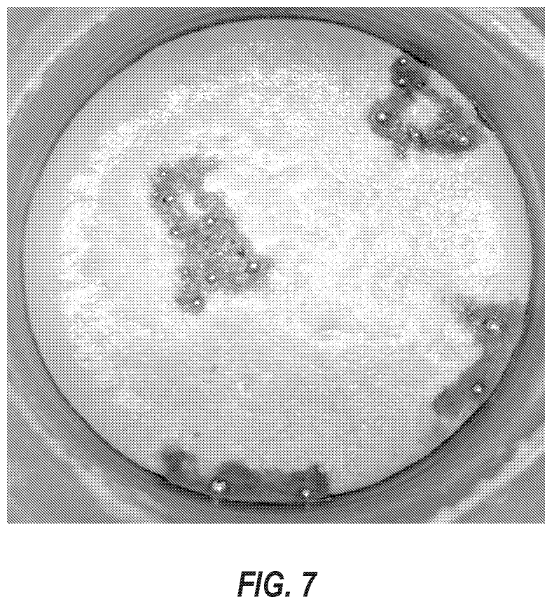

The efficacy of this approach was also demonstrated in ionic solutions with initial pH not equal to 7. First, 10 mL of 0.1 M NaOH solution (pH 13) was prepared and reacted with 0.3 g of the activated aluminum in a 100 mL Erlenmeyer flask under otherwise similar conditions as the experiments discussed above. As shown in FIG. 7, as the reaction completed, liquid metal emerged from the reaction product and coalesced into mechanically separable beads, whose ultimate mass and recovery ratio was measured to be within error bars (±0.05) of 1. A similar experiment was conducted using 1 M HCl solution (pH 0), again resulting in the complete recovery—within error bars (±0.05)—of the activating gallium and indium as a mechanically-separable liquid metal alloy.

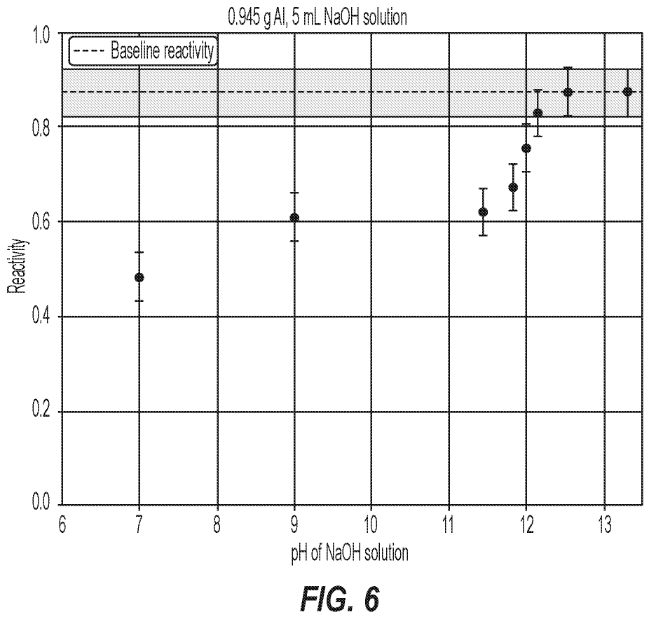

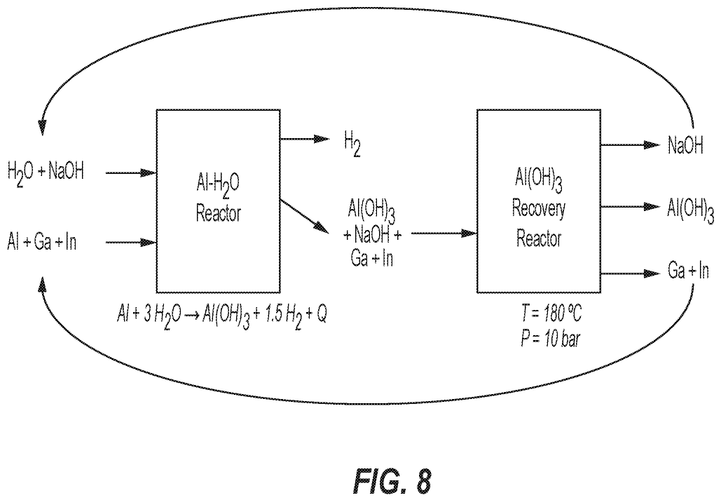

In separate trials, the quantity of hydrogen was measured for the reactions involving NaOH solution at varying concentrations. The aluminum-water reactions in these cases were carried out in an enclosed reaction chamber such that the reaction is completed isochorically (i.e., constant volume). The pressure and temperature within the chamber were measured throughout the reaction and used to compute the amount of hydrogen present in the chamber. In one set of trials, the volume of reaction solution was held constant at 5 mL and the mass of activated aluminum reacted was held constant as well at 0.9 g. Only the ionic strength—and therefore pH—of the input aqueous solution was varied by varying the concentration of NaOH. As shown in FIG. 6, increasing the ionic strength has the added benefit of increasing the amount of hydrogen produced for the same volume of water. The reactivity is taken as the ratio of the hydrogen measured from the reaction divided by the theoretical stoichiometric hydrogen yield for the amount of aluminum introduced into the reaction chamber. The NaOH could be regenerated from a system utilizing this observed phenomenon using the process outlined in FIG. 8.

The importance of ionic strength in gallium-indium alloy recovery has been demonstrated by comparing the reaction products in ionic aqueous solutions to non-ionic aqueous solutions of equivalent solute concentrations. Specifically, experiments were conducted in which 0.3 g activated aluminum pellets were reacted individually with 10 mL of the following aqueous solutions: deionized water (pH 7), 3 M glucose solution, 3 M sucrose solution, 3 M NaCl, and 3 M KCl. In the reactions with deionized water, 3 M glucose solution, and 3 M sucrose solution—all of which have an ionic strength equal to 0 due to lack of dissociation of the solute into ions—no liquid gallium-indium alloy was observed or able to be extracted after the reaction was complete. In the reactions with 3 M NaCl and 3 M KCl solutions—both solutions with ionic strength equal to 3 M—liquid gallium-indium alloy was recovered at a recovery fraction equal to 1 within error bars (+0.05).

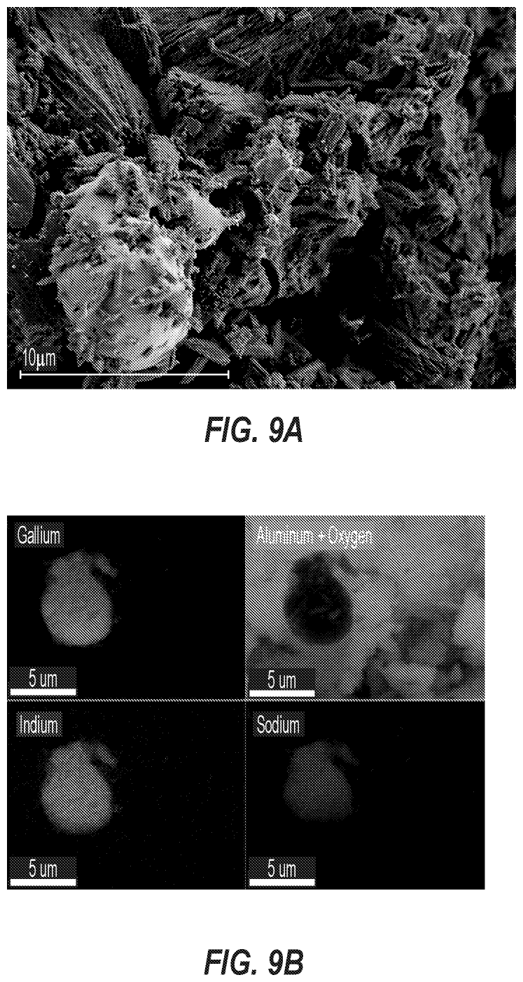

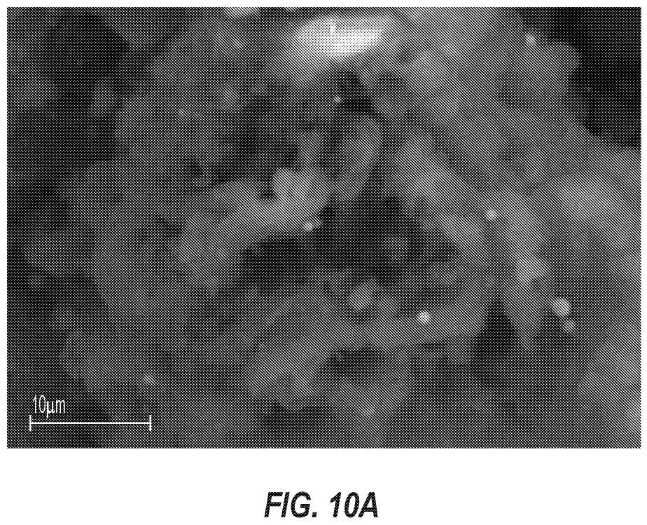

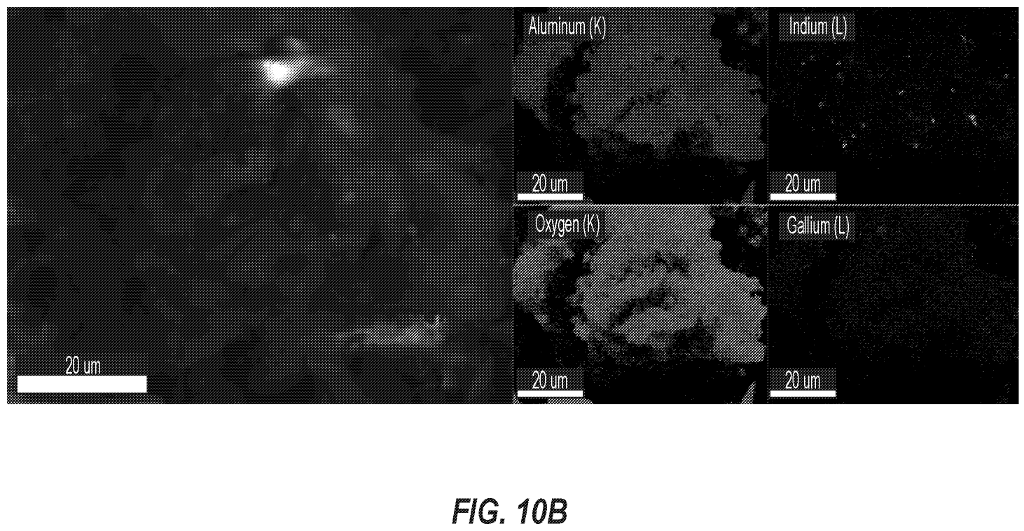

Finally, it has been shown that under non-ionic initial reaction conditions (i.e., activated aluminum reacted with de-ionized water, initially at pH 7), the indium can dealloy from the initial gallium-indium alloy over the course of the reaction, inducing the formation of solid indium agglomerations with an average characteristic diameter ranging from 0.1-10 micrometers. FIG. 10A shows an SEM image of the agglomeration and FIG. 10B shows a ZAF-corrected EDS atomic map of the same sample showing its high indium concentration. These indium agglomerations have limited mobility in the bulk reaction product, making them difficult to separate using mechanical means. The methods discussed herein prevent this dealloying from occurring and enable the gallium-indium alloy to remain a liquid throughout the reaction and thus easily separable once the reaction is complete. FIG. 9A shows a SEM image of the byproduct of the activated aluminum-water reaction in NaOH solution with an ionic strength of 0.1 M, indicating the presence of the gallium-indium alloy in liquid phase. ZAF-corrected EDS atomic maps in FIG. 9B for the same sample indicate the presence of gallium and indium in the liquid agglomeration in a ratio consistent with the original composition of the gallium-indium alloy initially used to treat the aluminum samples.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “cither.” “one of,” “only one of,” or “exactly one of.” “Consisting essentially of.” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03

1. A method of producing hydrogen gas, comprising:
reacting an activated aluminum composition comprising aluminum and an activating composition with a solution comprising water and at least one selected from the group of an ionic salt, a hydroxide, and an acid in a reaction chamber to produce hydrogen gas and one or more reaction products; and
forming a separate phase including the activating composition after reacting the activated aluminum with the water.

2. The method of claim 1, further comprising dispensing the activated aluminum from a first reservoir into the reaction chamber prior to reacting.

3. The method of claim 1, further comprising dispensing the ionic salt, the hydroxide, or the acid from a second reservoir into the reaction chamber prior to reacting.

4. The method of claim 1, further comprising dispensing the water from a third reservoir into the reaction chamber prior to reacting.

5. The method of claim 1, wherein the activating composition comprises gallium and/or indium.

6. The method of claim 1, wherein the solution comprises the ionic salt.

7. The method of claim 6, wherein the ionic salt comprises NaCl, KCl, NaHCO₃, MgCl₂, and/or CaCl₂).

8. The method of claim 1, wherein the solution comprises the hydroxide.

9. (canceled)

10. The method of claim 1, wherein the solution comprises the acid.

11-12. (canceled)

13. The method of claim 1, further comprising maintaining a wetted activating composition after reacting the activated aluminum with the water.

14. The method of claim 1, wherein forming the separate phase of the activating composition includes separating the activating composition from one or more reaction products of the activated aluminum and the water.

15. The method of claim 1, further comprising flowing the separate phase including the activating composition from the reaction chamber to a recovery chamber.

16. A system, comprising:
a first reservoir configured to contain an activated aluminum composition comprising aluminum and an activating composition;
a second reservoir configured to contain an ionic salt, a hydroxide, and/or an acid; and
a reaction chamber in fluid communication with the first reservoir and the second reservoir, wherein the first reservoir is configured to dispense the activated aluminum into the reaction chamber, wherein the second reservoir is configured to dispense the ionic salt, the hydroxide, and/or the acid into the reaction chamber, and wherein the reaction chamber is configured such that the activated aluminum reacts with water in the reaction chamber in the presence of the ionic salt, the hydroxide, and/or the acid to produce hydrogen gas and one or more reaction products.

17. The system of claim 16, wherein the second reservoir is configured to dispense the ionic salt, the hydroxide, and/or the acid into the reaction chamber in an amount sufficient to cause the activating composition to form a separate phase after the activated aluminum reacts with the water.

18. The system of claim 16, further comprising a separation system configured to separate the activating composition from the one or more reaction products.

19. The system of claim 16, further comprising a recovery chamber in fluid communication with the reaction chamber, wherein the recovery chamber is configured to receive the separate phase of the activating composition from the reaction chamber.

20. The system of claim 16, further comprising a third reservoir configured to contain water, wherein the third reservoir is configured to dispense the water into the reaction chamber.

21. The system of claim 16, wherein the ionic salt, the hydroxide, and/or the acid is dissolved in water.

22. The system of claim 16, wherein the activating composition comprises gallium and/or indium.

23. The system of claim 16, further comprising the ionic salt disposed in the second reservoir.

24. (canceled)

25. The system of claim 16, further comprising the hydroxide disposed in the second reservoir.

26. (canceled)

27. The system of claim 16, further comprising the acid disposed in the second reservoir.

28. (canceled)

29. The system of claim 16, further comprising one or more processors configured to control the amount of the activated aluminum, the ionic salt, the hydroxide, and/or the acid, and/or the water entering the reaction chamber.

30. (canceled)

31. A system, comprising:
a first reservoir configured to contain an activated aluminum composition comprising aluminum and an activating composition;
a second reservoir configured to contain a solution comprising water and an ionic salt, a hydroxide, and/or an acid dissolved in the water;
a reaction chamber in fluid communication with the first reservoir and the second reservoir, wherein the first reservoir is configured to dispense the activated aluminum into the reaction chamber, wherein the second reservoir is configured to dispense the solution into the reaction chamber, and wherein the reaction chamber is configured such that the activated aluminum reacts with the water in the presence of the ionic salt, the hydroxide, and/or the acid to produce hydrogen gas and one or more reaction products, wherein the amount of the ionic salt, the hydroxide, and/or the acid is sufficient to cause the activating composition to form a separate phase after the activated aluminum reacts with the water;
a separation system configured to separate the activating composition from one or more reaction products; and
a recovery chamber in fluid communication with the reaction chamber, wherein the recovery chamber is configured to receive the separate phase of the activating composition from the reaction chamber.

32. The system of claim 31, wherein the activating composition comprises gallium and/or indium.

33-35. (canceled)
